(19) United States
(12) Patent Application Publication
(10) Pub. No.: US 2007/0253207 A1
(43) Pub. Date: Nov. 1, 2007

(54) FLASHLIGHT MOUNTING SYSTEM

(76) Inventors: Christopher E. Coombs, Deerfield, NH (US); Alan T. Howe, Merrimack, NH (US)

Correspondence Address: INSIGHT TECHNOLOGY, INC.;ATTN: PETER W. MURPHY, NINE AKIRA WAY, LONDONDERRY, NH, 03053, US

(21) Appl. No.: 11/738,604

(22) Filed: Apr. 23, 2007

Related U.S. Application Data
(60) Provisional application No. 60/795,318, filed on Apr. 27, 2006.

(51) Int. Cl. F21S 8/08

(52) U.S. Cl. 362/418; 362/648; 362/421

(57) ABSTRACT

A rail mounting assembly for coupling a flashlight or other instrument to a fixed point on a person's body, clothing, equipment or accessories allows a user to direct or otherwise fix light upon a person or area of interest. The rail mounting assembly may have a dovetail profile for mating with a cooperating flashlight

### CROSS REFERENCE TO RELATED APPLICATIONS

The present application claims the benefit of U.S. provisional patent applications Ser. No. 60/795,318, filed Apr. 27, 2006, the entire disclosure of which is incorporated herein by reference.

### BRIEF DESCRIPTION OF THE DRAWINGS

FIG. 1A is a photograph of a firefighter face piece assembly with a coupled flashlight consistent with one embodiment of the invention.

FIG. 1B is a closer-up photograph of a portion of the firefighter face piece assembly with the coupled flashlight of FIG. 1A.

FIG. 2 is a photograph of a rear view of the firefighter face piece assembly with the coupled flashlight of FIG. 1A.

FIG. 3 is a perspective view of the flashlight of FIG. 1A.

FIG. 4A is a top view of a first rail mounting assembly for coupling a flashlight to the firefighter face piece of FIG. 1A consistent with one embodiment of the invention.

FIG. 4B is side view of the first rail mounting assembly of FIG. 4A.

FIG. 5A is a partial section view of a rail mounting structure consistent with one embodiment of the invention.

FIG. 5B is a partial side view of the rail mounting structure of FIG. 5A.

FIG. 6 is a section view of a second rail mounting assembly consistent with one embodiment of the invention.

### DETAILED DESCRIPTION

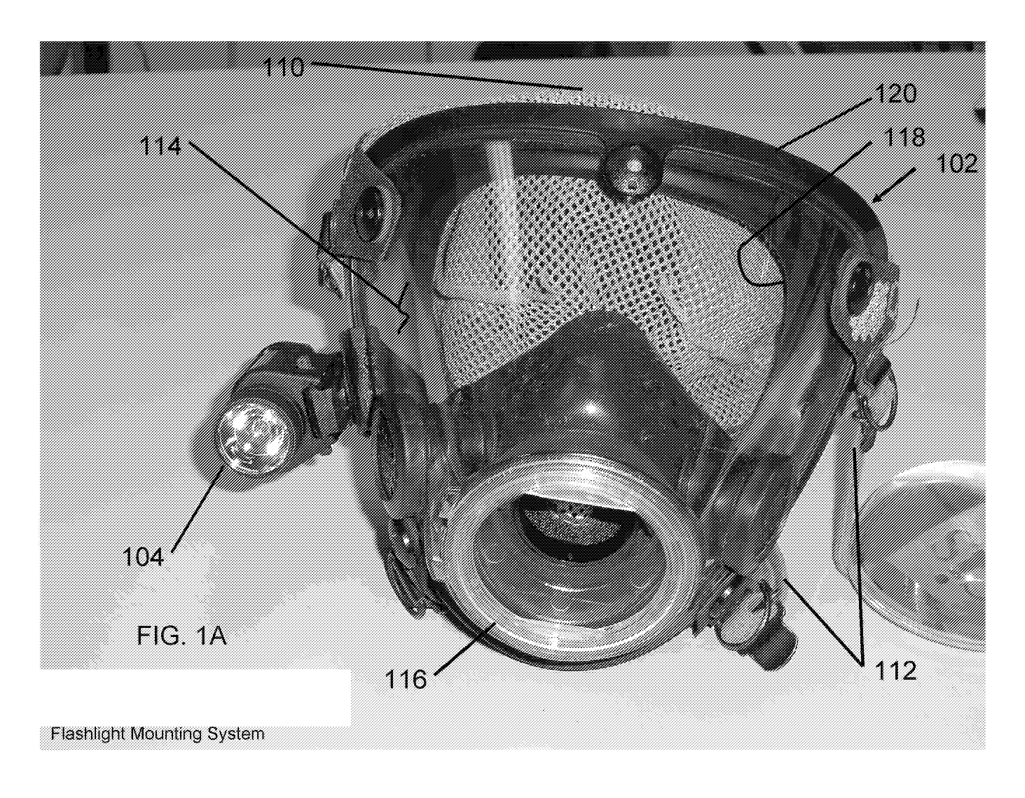

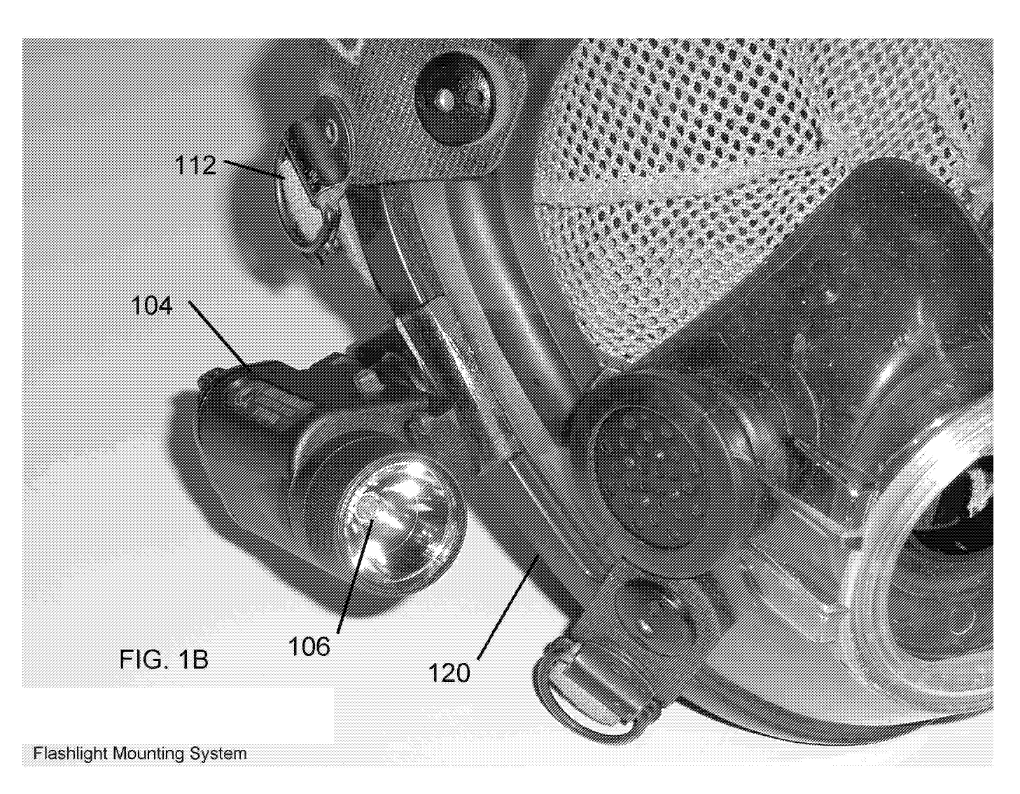

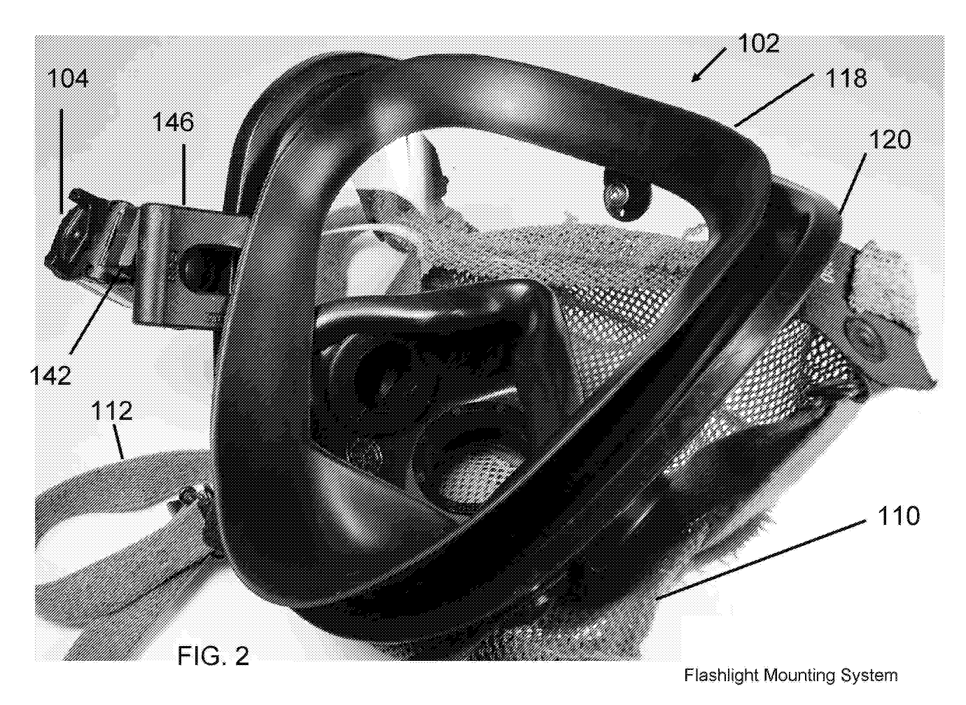

FIGS. 1A, 1B, and 2 are photographs showing a firefighter face piece assembly 102 with a coupled flashlight 104 consistent with one embodiment of the invention. The face piece assembly 102 may be worn with any protective helmet, for example a standard firefighter helmet having a single piece molded construction in a shape that generally incorporates a crown covering portion and a brim. The face piece assembly 102 may have a net/mesh portion 110 and one or more adjustable straps 112 for securing the face piece assembly 102 at least partially over the face of the user. The face piece assembly 102 may have a lens 114 with a nose cup 116, a seal 118, and a clamp 120 for coupling the seal 118 to the lens 114. Air may enter the face piece assembly 102 through the nose cup 116 from a portable air source (not shown). With the seal 118 properly in contact with the head of the user, the air source may provide a positive pressure to help ensure outside air does not enter the face piece assembly 102.

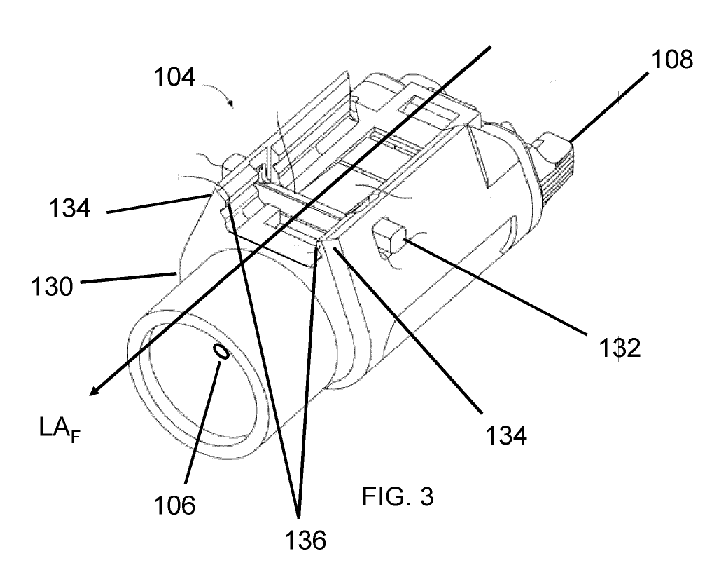

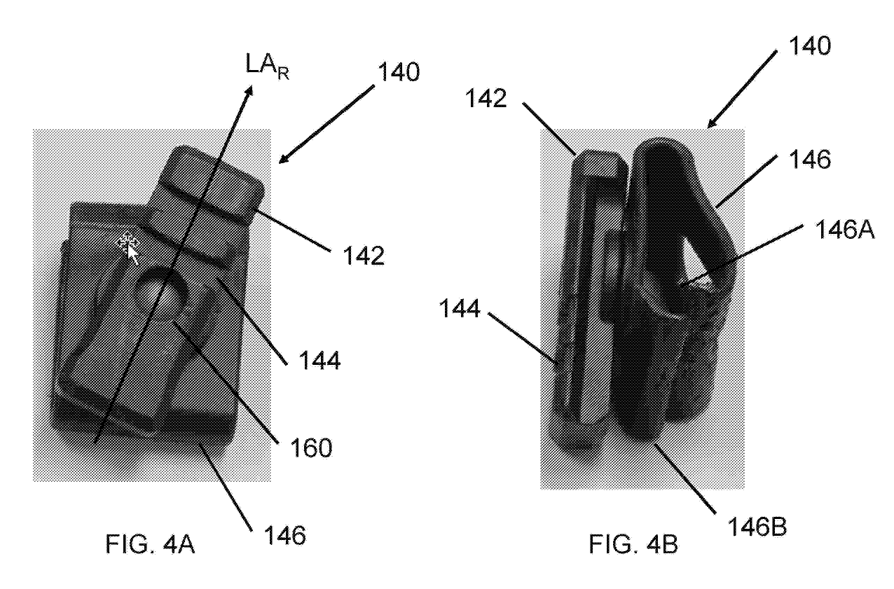

FIG. 3 is a perspective view of the flashlight 104 consistent with one embodiment of the invention and FIG. 4A is a top view and FIG. 4B is a side view of a first rail mounting assembly 140 consistent with one embodiment of the invention for coupling the flashlight 104 to a firefighter helmet, face piece, face/eye protector, head harness, self contained breathing apparatus, belt, clothing, wrist band or wristlet, riot shield, or other equipment. The flashlight 104 may have an incandescent, LED or other light source 106 powered by a battery or other power source enclosed at partially in a housing 130 having generally parallel elongated rigid projections 134 extending generally parallel to a longitudinal axis LA_{F}. The elongated projections 134 may have a contoured inner surface 136 having both concave and convex surfaces that are configured to allow sliding action along a longitudinal axis LA_{R} with a cooperating rail mounting structure 142. The elongated projections 134 may be spaced a fixed distance from each other.

The flashlight 104 may include a spring biased bar 132 configured to cooperate with a cross slot 144 in the cooperating rail mounting structure 142 of the first rail mounting assembly 140 to allow the user to attach/detach the flashlight to/from the first rail mounting assembly 140. The flashlight 104 may include one or more actuators 108 for controlling the on/off status of the light source 106.

A cooperating flashlight may be removably coupled to the cooperating rail mounting structure 142 using a variety of mounting methods, for example the mounting method described in issued U.S. Pat. No. 6,574,901, pending U.S. patent application Ser. No. 11/678,383 (both of which a incorporated herein by reference in their entirety), a linearly slidable bar generally perpendicular to the rigid elongated projections, a side clamp, or any other mounting method that allows the user to selectively attach and detach the flashlight to the cooperating rail mounting structure 142. For example, one of the elongated rigid projections and a cross bar may be fixed to a housing and the other projection may be rotatable parallel to a longitudinal axis and biased by a spring and/or a mechanical fastener, such as a screw, towards the first projection.

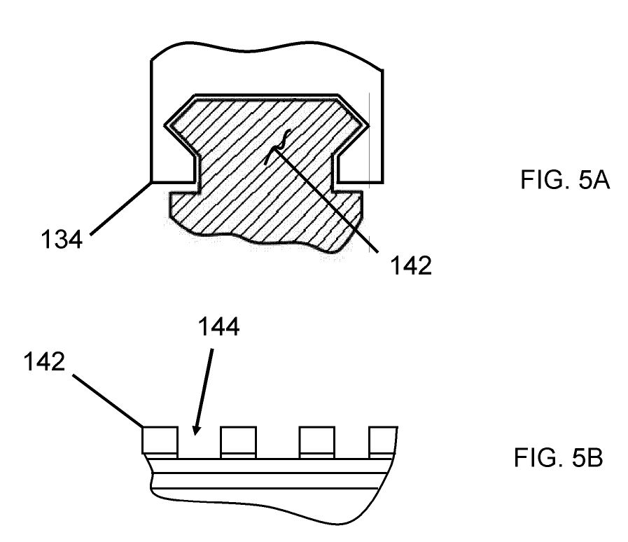

FIG. 5A is a partial section view and FIG. 5B is a partial side view of the first rail mounting structure 142. The rail mounting structure 142 may have a dovetail profile that is similar in design to a MIL-STD-1913 rail, a Weaver profile, or other dovetail profile. A dovetail profile may flare outward in the shape of a dove's tail. The profile may have a wider section disposed between two narrower sections. Variations in the profile of the rail mounting structure 142 or the size or spacing of the cross slot(s) 144 may be made without departing from the invention.

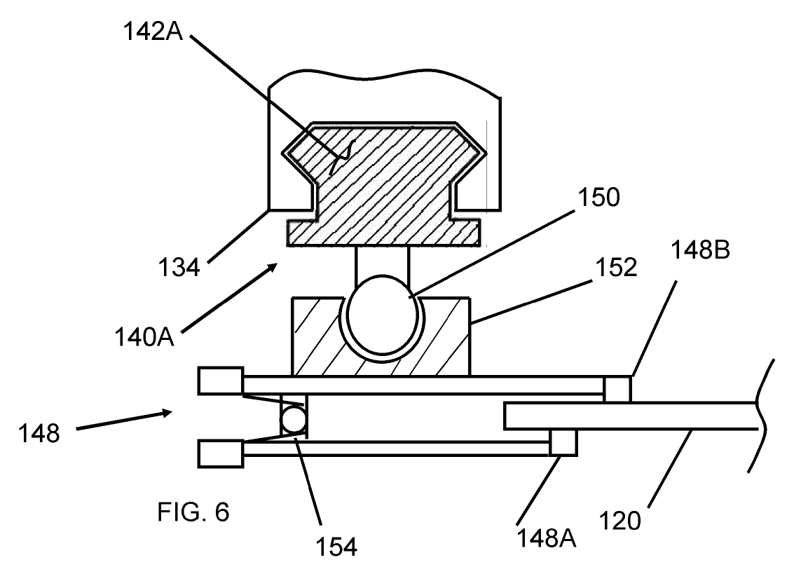

The rail mounting assembly 140 may have a clamping portion 146 coupled to the rail mounting structure 142 with a single degree of freedom coupler 160 to allow the rail cooperating rail mounting structure 142 to rotate relative to the clamping portion 146. Alternatively, as shown in FIG. 6, a second rail mounting assembly 140A may have a cooperating rail mounting structure 142A coupled to a clamping portion 146A with a multiple degree of freedom coupler that allows the cooperating rail mounting structure 142A and the clamping portion 146A to move in two or more degrees of freedom, for example using a ball 150 and socket 152, a universal joint, or a gimbal.

The clamping portion 146 may have one or more end portions 146A, 146B and a clamping portion 148 may have one or more end portions 148A, 148B configured to grasp the clamp 120 or any other object. The clamping portions 146, 148 may be formed from a single piece of material, for example metal or plastic, or from two or more pieces of material and a spring 154 or other mechanism. The clamping portions 146, 148 may be configured to bias the ends 148A, 148B, 148A, 148B towards each other to provide a clamping force. The clamping portions 146, 148 may be secured in a variety of positions along the clamp 120 of the face piece assembly 102 so as not to interfere with the seal 118.

Although reference has been made to firefighters, other users desiring hands-free lighting, including peace officers, first responder, industrial workers, sports persons, miners and cave spelunkers, high climbers, may benefit.

In one embodiment, the rail mounting system may provide as a flashlight, utensil, instrument or device mounting point that accepts products manufactured with the interface to mate to a cooperating rail structure, for example a MIL-STD-1913 or a Weaver rail, to allow for the attachment to be firmly fixed and aimed (oriented) to free the user's hands to accomplish the mission. Interchangeability, standardization of mounting system, and hands-free stability are maintained and provide one or more degrees of freedom to the user.

In another embodiment, the rail mounting system may be attached to the brim of a protective helmet, protective face/eye protector, or a head harness to allow a flashlight to be affixed thereto and provide one or more degrees of freedom.

In another embodiment, the rail mounting system may be attached to a wrist band or wristlet (bracelet) to allow a flashlight to be affixed thereto and provide one or more degrees of freedom.

In another embodiment, the rail mounting system may be attached to the harness of a self contained breathing apparatus or back support harness to allow a flashlight to be affixed thereto and provide one or more degrees of freedom.

In another embodiment, the rail mounting structure may be coupled to a police riot shield to allow a flashlight to be coupled thereto to provide one or more degrees of freedom.

In another embodiment, the rail mounting system may be coupled to a user's clothing or equipment to allow a flashlight to be coupled thereto to provide one or more degrees of freedom.

Although several embodiments have been described in detail herein, the invention is not limited hereto. It will be appreciated by those having ordinary skill in the art that various modifications can be made without materially departing from the novel and advantageous teachings of the invention. Accordingly, the embodiments disclosed herein are by way of example. It is to be understood that the scope of the invention is not to be limited thereby.

What is claimed:

1. A rail mounting assembly for securing a flashlight to a face piece assembly having a clamp for coupling a lens to a seal, comprising:
a rail structure having an elongated dovetail profile that cooperates with contoured inward surfaces of a flashlight;
a clamping portion configured to engage the clamp without interfering with the seal; and
a coupler for allowing the rail structure to move relative to the clamping portion in at least one degree of freedom.

2. The mounting assembly of claim 1, wherein the coupler allows the rail structure to move relative to the clamping portion in at least two degrees of freedom.

3. The mounting assembly of claim 1, wherein the coupler allows the rails structure to move relative to the clamping portion in three degrees of freedom.

4. The mounting assembly of claim 1, wherein the rail structure further comprises a cross slot that cooperate with a bar on the flashlight to limit longitudinal motion of the flashlight relative to the rail structure.

5. The mounting assembly of claim 1, wherein the clamping portion further comprises a spring.

6. The mounting assembly of claim 1, wherein the clamping portion comprises end portions for grasping opposing sides of the clamp.

7. The mounting assembly of claim 1, wherein the clamping portion comprises a plastic or a metal.

8. The mounting assembly of claim 1, wherein the rail structure profile is a selected one of a Weaver and a MIL-STD-1913 profile.

9. A mounting assembly for securing a flashlight or other instrument to a fixed point on a person's body, clothing, equipment, or accessories, comprising:
a rail structure having an elongated dovetail profile and a cross slot;
a clamping portion having a first end and a second end, the clamping portion configured to bias the first end and the second towards each other; and
a coupler for allowing the rail structure to move relative to the clamping portion in at least one degree of freedom.

10. The mounting assembly of claim 9, wherein the coupler allows the rail structure to move relative to the clamping portion in at least two degrees of freedom.

11. The mounting assembly of claim 9, wherein the coupler allows the rails structure to move relative to the clamping portion in three degrees of freedom.

12. The mounting assembly of claim 9, wherein the cross slot on the rail structure cooperates with a bar on the flashlight to limit longitudinal motion of the flashlight relative to the rail structure.

13. The mounting assembly of claim 9, wherein the clamping portion further comprises a spring.

14. The mounting assembly of claim 9, wherein the clamping portion comprises end portions for grasping.

15. The mounting assembly of claim 9, wherein the clamping portion comprises a plastic or a metal.

16. The mounting assembly of claim 1, wherein the rail structure profile is selected one of a Weaver and a MIL-STD-1913 profile.

17. A flashlight mounting system for securing a flashlight to a fixed point on a person's body, clothing, equipment, or accessories, comprising:
a mounting assembly having a rail structure with an elongated dovetail profile and a cross slot; a clamping portion having a first end and a second end, the clamping portion configured to bias the first end and the second towards each other; and a coupler for allowing the rail structure to move relative to the clamping portion in at least one degree of freedom; and
a flashlight having an enclosure for at least partially enclosing a source of illumination and a power source, the enclosure having a first and a second elongated projection having inner surfaces that cooperate with the dovetail profile to limit travel along a longitudinal axis and a bar alignable with the cross slot to restrict motion along the longitudinal axis.

18. The flashlight mounting system of claim 17, wherein the elongated projections are spaced by a fixed distance and the bar is biased by a spring to urge the bar into the cross slot.

19. The flashlight mounting system of claim 17, wherein a cross bar and the first elongated projections are fixed to the enclosure and the second projection is moveable in a direction generally perpendicular to the first elongated projection.

20. The flashlight mounting system of claim 17, wherein the coupler allows the rails structure to move relative to the clamping portion in three degrees of freedom.
